(19) United States
(12) Patent Application Publication
(10) Pub. No.: US 2005/0057023 A1
(43) Pub. Date: Mar. 17, 2005

(54) Anti-twisting inflatable curtain assembly

(76) Inventors: Thomas C. Burton, Salt Lake City, UT (US); Brian Fulmer, Hooper, UT (US); Travis Hess, Farr West, UT (US)

Correspondence Address: Sally J. Brown;AUTOLIV ASP. INC., 3350 Airport Road, Ogden, UT, 84405, US

(21) Appl. No.: 10/663,139

(22) Filed: Sep. 16, 2003

(51) Int. Cl. B60R 21/22

(52) U.S. Cl. 280/730.2

(57) ABSTRACT

An airbag assembly that includes an inflatable curtain and a stiffening member is disclosed. The stiffening member is attached at or near the top end of the curtain. Such attachment may be accomplished via a variety of methods including fasteners, mounting brackets, sewing, inserting the stiffening member into a pocket in the curtain, or by passing one or more of the curtain's attachment tabs through slits located on the stiffening member. The stiffening member is designed to extend along at least a portion of the longitudinal length of the inflatable curtain. In one embodiment, the stiffening member is constructed to resist twisting of the inflatable curtain along a portion of the longitudinal length. In an alternative embodiment, the stiffening member is constructed such that when the inflatable curtain is twisted, the stiffening member deforms the inflatable curtain such that the curtain cannot be installed onto a vehicle interior without first correcting the deformation.

### BACKGROUND OF THE INVENTION

1. Field of the Invention

The present invention relates to an inflatable curtain airbag assembly. More specifically, the present invention relates to a novel inflatable curtain airbag assembly that includes a stiffening member that is designed to resist or prevent twisting of the inflatable curtain or to prevent installation into a vehicle when the inflatable curtain is twisted.

2. Description of Related Art

Inflatable airbags are well accepted for use in motor vehicles and have been credited with preventing numerous deaths and injuries. In fact, the inclusion of inflatable safety restraint devices, or airbags, is now a legal requirement for many new vehicles. Airbags are typically installed in the steering wheel and in the dashboard on the passenger side of a car. In the event of an accident, an accelerometer within the vehicle measures the abnormal deceleration and triggers the ignition of a pyrotechnic charge. Expanding gases from the charge fill the airbags, which immediately inflate in front of the driver and passenger to protect them from impact against the windshield. Side impact airbags have also been developed in response to the need for similar protection from impacts in a lateral direction, or against the side of the vehicle.

Recently, airbag technology has continued to advance such that inflatable curtain airbags are now enlisted to provide roll-over protection as well as side impact protection. During a roll-over accident, the vehicle occupants can be jostled considerably, thereby causing the occupant to impact various parts of the vehicle interior. Even worse, the occupant may be ejected from the vehicle. Alternatively, a head or limb of an occupant may extend outside the vehicle during the roll-over. Such “occupant excursion” during roll-over accidents is a common cause of automotive fatality, particularly in the case of vehicle occupants that are not wearing a seat belt during the roll-over.

Conventional curtain airbags attempt to combat the dangers of side impact or roll-over accidents by having a curtain airbag unroll or unfold downward from the roof of the vehicle and then inflate beside the person as a means of preventing the person from hitting the door, window, or lateral side of the vehicle. Since a vehicle occupant may be leaning forward, reclined in the seat, or at any position in between, such curtain airbags are usually designed to be long enough to cover the whole interior side of the vehicle, protecting occupants in both front and rear passenger compartments.

Generally, the inflatable curtain airbag must be sized to hold large volumes of inflation gas and to descend below the window sill. Consequently, when not inflated the curtain airbag includes a significant amount of material. This material is then rolled, folded, or otherwise gathered to form a tight, tubular bundle. A wrapper (sometimes called a “sock”) that fits around the curtain is then added to ensure that the curtain airbag is kept rolled or folded.

The curtain is stored and mounted either on or proximate a roof rail of the vehicle. Such mounting is generally accomplished via a two-step process. First, the curtain must be held in the proper position. This can be done by either having multiple workers hold the airbag or by attaching the airbag to sophisticated jigs, hooks, or mounting brackets (collectively “brackets”) that have been placed into slots in the body of the vehicle. Once the curtain airbag has been secured in the proper location, the workers are free to affix the curtain airbag assembly to the vehicle using fasteners such as bolts, screws, rivets, and the like. Usually these fasteners are threaded into one or more attachment tabs that have been added along the top of the curtain airbag to facilitate the assembly and mounting process.

Although inflatable curtain airbag systems have significantly increased the overall safety of the vehicle, problems and challenge still exist that limit the ability of airbag and vehicle manufacturers to implement and use inflatable curtains on all types of vehicles. One such problem relates to the fact that once the curtain has been rolled or folded into a tubular-shaped bundle, portions of the curtain tend to twist, kink, or become otherwise entangled. This twisting of the inflatable curtain is detrimental because if a vehicle manufacturer installs the curtain onto a vehicle in this twisted shape, there is an increased likelihood that the curtain will deploy improperly and/or otherwise malfunction during an accident. Vehicle occupants are endangered thereby.

In an attempt to reduce the likelihood that the inflatable curtain will be installed on a vehicle with a twisted shape, some recent inflatable curtains have been made with alignment lines or other similar markings that give a visual indication to the airbag installer if the curtain has been assembled having a twist or other entanglement. Unfortunately however, many vehicle manufacturers disfavor the use of these alignment lines because they believe that a visual inspection of the alignment lines does not provide a reliable and repeatable mechanism for determining whether the installed curtain contains a twist.

Accordingly, there is a need in the art for a novel inflatable curtain airbag assembly that addresses and/or solves one or more of the above-listed problems. Such a device is disclosed herein.

### SUMMARY OF THE INVENTION

The apparatus of the present invention has been developed in response to the present state of the art, and in particular, in response to the problems and needs in the art that have not yet been fully solved by currently available inflatable curtain airbag assemblies. Thus, the present invention provides an airbag assembly that includes an inflatable curtain airbag. The inflatable curtain is designed and positioned such that in the event of an accident or crash, the curtain will deploy and cover all or a portion of the vehicle's door, window, lock switch and/or lateral side.

The inflatable curtain has a top end, a bottom end, and a longitudinal length. The longitudinal length extends along the roof rail of the vehicle. One or more attachment tabs may additionally be added to the curtain proximate to the top end.

The inflatable curtain has two configurations: a stowed configuration in which the inflatable curtain has been rolled, folded, or otherwise gathered into a bundle, and an inflated configuration that is capable of protecting a vehicle occupant during a crash. When the inflatable curtain is in the stowed configuration, the bottom end is preferably in the interior of the bundle.

The airbag assembly further comprises a stiffening member. More than one stiffening member may also be used. The stiffening member is a bar, plate, rod, prism, pyramid, or any other desired shape or feature that is disposed at or proximate to the top end. The stiffening member is designed such that it extends along all or a portion of the longitudinal length of the curtain.

In one embodiment, the stiffening member is made of a plastic material such as polypropylene and has a thickness that is between about 1 to about 3 millimeters. Of course, other embodiments may also be made in which the stiffening member is made of metal, composite materials, other plastics, or other similar materials. Still further embodiments may be made in which the thickness of the stiffening member is greater than about 3 millimeters. Other embodiments may have the thickness of the stiffening member be less than about 1 millimeter.

The stiffening member is attached to or below the attachment tabs. Such attachment may be accomplished via a variety of methods including fasteners, mounting brackets, sewing, inserting the stiffening member into a pocket in the curtain, or by passing one or more of the curtain's attachment tabs through slits located on the stiffening member.

The stiffening member is designed to extend along the longitudinal length of the inflatable curtain. In one embodiment, the stiffening member extends along the entire longitudinal length of the curtain. Other embodiments may also be made in which the stiffening member extends along only a portion of the longitudinal length. In further embodiments, the stiffening member will be positioned between two of the attachment tabs.

The stiffening member may be constructed such that when it is attached to the curtain, the stiffening member resists twisting of the curtain along a portion of the longitudinal length. However, other embodiments may also be made in which the stiffening member is constructed such that when the inflatable curtain is twisted, the stiffening member deforms the inflatable curtain such that the curtain cannot be installed onto a vehicle interior without first correcting the deformation.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partially cutaway perspective view of a vehicle interior having one embodiment of the airbag assembly of the present invention mounted above the vehicle door;

FIG. 2 is a side plan view of a further embodiment of the airbag assembly of the present invention;

FIG. 3 is a partially cutaway side plan view of an alternative embodiment of the airbag assembly of the present invention

FIG. 4 is a partially cutaway side plan view of a different embodiment of the airbag assembly of the present invention;

FIG. 5 is a partially cutaway side plan view of a further embodiment of the airbag assembly of the present invention;

FIG. 6 is a partially cutaway side plan view of a different embodiment of the airbag assembly of the present invention; and

FIG. 7 is a partially cutaway perspective view of the embodiment of the airbag assembly shown in FIG. 6.

### DETAILED DESCRIPTION OF THE PREFERRED EMBODIMENTS

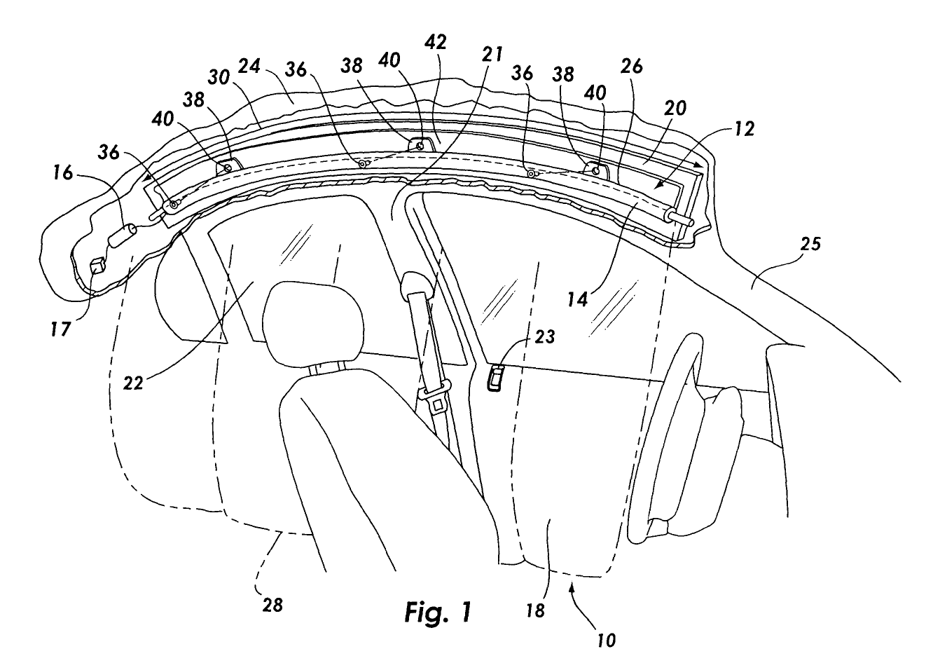

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 7, is not intended to limit the scope of the invention, as claimed, but is merely representative of presently preferred embodiments of the invention.

Referring to FIG. 1, a vehicle interior 10 is depicted with an attached airbag assembly 12. The airbag assembly 12 includes an inflatable side curtain airbag 14 that is attached to an inflator 16. The inflator 16 is a pyrotechnic or other device that provides inflation gas to the inflatable curtain 14 during an accident. A sensor 17 that detects a crash and/or provides an initiation signal to initiate the inflation of the inflatable curtain 14 when an accident occurs may also be added.

Generally, the inflatable curtain 14 is positioned above the vehicle door 18 along a roof rail 20. The inflatable curtain 14 has two configurations: a stowed configuration in which the inflatable curtain 14 has been rolled, folded, or otherwise gathered into a bundle, and an inflated configuration (shown in phantom lines) that deploys downwards along the door 18 during a crash. As can be seen in FIG. 1, the inflatable curtain 14 is preferably sized such that when in the inflated configuration, the inflatable curtain 14 will cover all or substantial portions of the door 18, the lateral side 21, the windows 22, and the lock switch 23.

As the roof rail 20 and the inflatable curtain 14 are often not visually appealing to the customer, a vehicle headliner 24 and/or decorative trim 25 are usually added to increase the aesthetic attractiveness of the vehicle interior 10. The headliner 24 and/or the trim 25 generally cover the roof rail 20 and the inflatable curtain 14. For purposes of clarity however, portions of the headliner 24 shown in FIG. 1 have been cut away so that the components of the airbag assembly 12 may be fully visible.

The curtain airbag 14 includes a top end 26, a bottom end 28, and a longitudinal length 30. When the curtain 14 is in the stowed configuration, the bottom end 28 is positioned on the interior of the bundle. The longitudinal length 30 extends along the roof rail 20. As shown in FIG. 1, the longitudinal length 30 of the inflatable curtain 14 is substantially the same as the length of the roof rail 20. Of course, other embodiments may also be made in which the longitudinal length 30 either larger or smaller than the length of the roof rail 20.

In order to ensure that the inflatable curtain 14 maintains a preferred position during the normal operation of the vehicle as well as during a crash or accident, the inflatable curtain 14 is permanently mounted or attached to the vehicle interior 10. Such attachment of the inflatable curtain 14 may be accomplished through the use of one or more fasteners 36. The fasteners 36 operate to bolt and/or affix the inflatable curtain 14 to the vehicle interior 10. As depicted in FIG. 1, the fasteners 36 comprise one or more bolts. Other types of fasteners 36, such as rivets, screws, nails, tethers, wire restraints, clips, clamps, tabs, hooks, and the like, may also be used.

To further facilitate the attachment of the inflatable curtain 14, one or more attachment tabs 38 may be added to the inflatable curtain airbag 14. In the embodiment shown in FIG. 1, three attachment tabs 38 are illustrated. These attachment tabs 38 are extensions or flaps that are positioned proximate the top end 28 and are designed to mount to the inflatable curtain 14 to the vehicle interior 10. More particularly, the attachment tabs 38 are flaps that are positioned on the top end 28 and include one or more holes 40 that are sized such that the fasteners 36 may pass through the attachment tabs 38 and bolt the inflatable curtain 14 to the vehicle interior 10.

Referring still to FIG. 1, the airbag assembly 12 further comprises a stiffening member 42. The stiffening member 42 is a bar, plate, rod, or other similar feature that is attachable to the vehicle interior 10 and/or the inflatable curtain 14. The stiffening member 42 is disposed at or proximate to the top end 28. More than one stiffening member 42 may also be used. More specifically, the stiffening member 42 extends along at least a portion of the longitudinal length 30 and is constructed such that when it attached to the inflatable curtain 14, the stiffening member 42 resists twisting of the curtain 14 along a portion of the longitudinal length 30.

In the embodiment shown in FIG. 1, the stiffening member 42 comprises a bar that is made of a plastic material such as polypropylene and has a thickness that is between about 1 to about 3 millimeters. As illustrated in FIG. 1, the stiffening member 42 is positioned outside of the inflatable curtain 14 and is constructed to extend along the entire longitudinal length 30 of the curtain 14. Those of skill in the art will recognize that other embodiments may be made in which the shape, configuration, material, and/or thickness of the stiffening member 42 differs from that which is shown in FIG. 1. For example, embodiments may be made in which the stiffening member 42 is constructed of metal, composite materials, other plastics, and/or other similar materials. Further embodiments may be made in which the thickness of the stiffening member 42 is greater than about 3 millimeters. Other embodiments may have the thickness of the stiffening member 42 be less than about 1 millimeter. Additional embodiments may have length of the stiffening member 42 be smaller than the longitudinal length 30. Yet additional embodiments may be constructed such that the shape of the stiffening member 42 corresponds to the shape of a vehicle interior 10.

The embodiment of the airbag assembly 12 has further been constructed such that the stiffening member 42 is connected to the attachment tabs 38 by the fasteners 36. Of course, other embodiments may have the stiffening member 42 be connected below the attachment tabs 38 and/or positioned between two of the attachment tabs 38. Further embodiments may be made in which the stiffening member 42 is attached to the inflatable curtain 14 via methods other than via the fasteners 36 such as through mounting brackets, adhesives, welding, gluing, sewing, weaving, bonding, and the like.

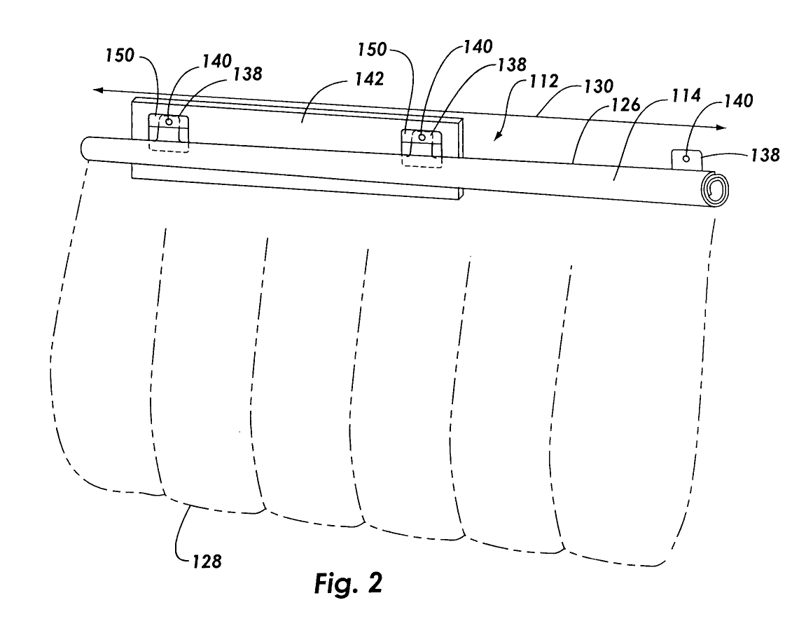

Referring now to FIG. 2, a further embodiment of the present invention is depicted. FIG. 2 is a side plan view of a airbag assembly 112 that may be mounted onto a vehicle interior 10 (shown in FIG. 1). As can be seen in FIG. 2, most of the components and elements of the airbag assembly 112 are similar and/or equivalent to the components and elements that are found in the embodiment described above.

The airbag assembly 112 comprises an inflatable curtain 114. The inflatable curtain 114 has two configurations: a stowed configuration in which the inflatable curtain 114 has been rolled, folded, or otherwise gathered into a bundle, and an inflated configuration (shown in phantom lines) that is capable of protecting a vehicle occupant during a crash. The inflatable curtain 114 has a top end 126, a bottom 128, and a longitudinal length 130. One or more attachment tabs 138 having a hole 140 may also be added proximate to the top end 126.

The airbag assembly 112 further comprises a stiffening member 142 that is attachable to the vehicle interior 110 and/or the inflatable curtain 114. The stiffening member 142 is disposed at or proximate to the top end 128. More than one stiffening member 142 may also be used. The stiffening member 142 extends along at least a portion of the longitudinal length 130 and is constructed such that when it is attached to the inflatable curtain 114, the stiffening member 142 resists twisting of the curtain 114 along a portion of the longitudinal length 130.

As with the previous embodiment, the stiffening member 142 is positioned outside the inflatable curtain 114 and is attached to the inflatable curtain 114 via the attachment tabs 138. However, unlike the embodiment described above, the stiffening member 142 is not attached to the inflatable curtain 114 via one or more fasteners. Rather, the stiffening member 142 is attached to the inflatable curtain 114 via one or more mounting brackets 150 that engage both an attachment tab 138 and a portion of the stiffening member 142.

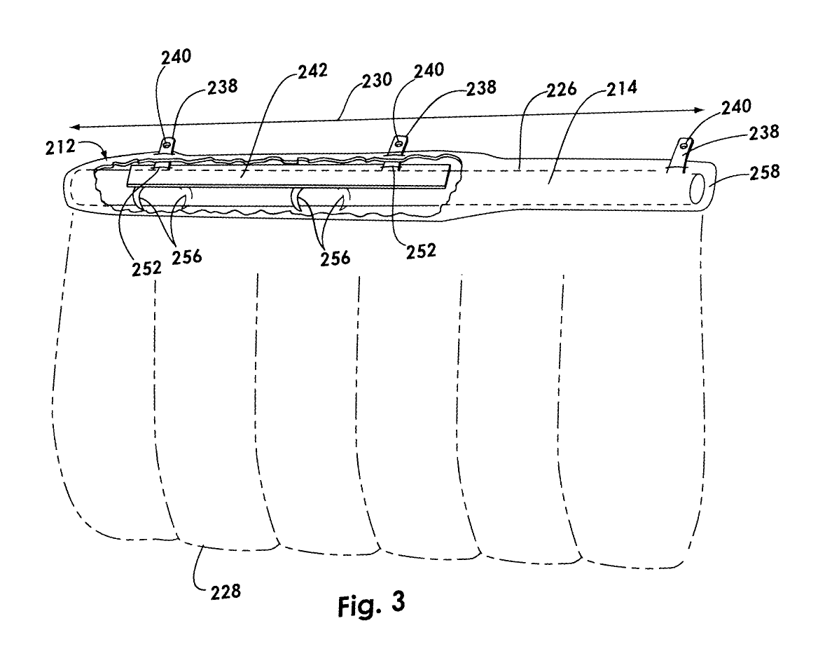

Referring now to FIG. 3, a further embodiment of the present invention is depicted. FIG. 3 is a partially cutaway side plan view of a airbag assembly 212 that may be mounted onto a vehicle interior 10 (shown in FIG. 1). As can be seen in FIG. 3, most of the components and elements of the airbag assembly 212 are similar and/or equivalent to the components and elements that are found in the embodiments described above.

The airbag assembly 212 comprises an inflatable curtain 214. The inflatable curtain 214 has two configurations: a stowed configuration in which the inflatable curtain 214 has been rolled, folded, or otherwise gathered into a bundle, and an inflated configuration (shown in phantom lines) that is capable of protecting a vehicle occupant during a crash. The inflatable curtain 214 has a top end 226, a bottom 228, and a longitudinal length 230. One or more attachment tabs 238 having a hole 240 may also be added proximate to the top end 226.

The airbag assembly 212 further comprises a stiffening member 242 that is attachable to the vehicle interior 210 and/or the inflatable curtain 214. The stiffening member 242 is disposed at or proximate to the top end 228. More than one stiffening member 242 may also be used. The stiffening member 242 extends along at least a portion of the longitudinal length 230 and is constructed such that when it is attached to the inflatable curtain 214, the stiffening member 242 resists twisting of the curtain 214 along a portion of the longitudinal length 230.

As with the previous embodiment, the stiffening member 242 is positioned outside the curtain 214 and is attached to the curtain 214 via one or more of the attachment tabs 238. However, unlike the previous embodiment, this attachment between the stiffening member 242 and the curtain 214 is preferably accomplished by passing one or more of the attachment tabs 238 through one or more slits 252 on the stiffening member 242. A wrapper 258 may also be added to enclose both the stiffening member 242 and the inflatable curtain 214.

Referring still to FIG. 3, the stiffening member 242 may further comprise one or more shape maintainers 256. The shape maintainers 256 are tabs, extensions, flaps, clips, straps, and the like that are designed to engage and hold the inflatable curtain 214 such that the curtain 214 maintains its rolled or folded shape in the stowed configuration.

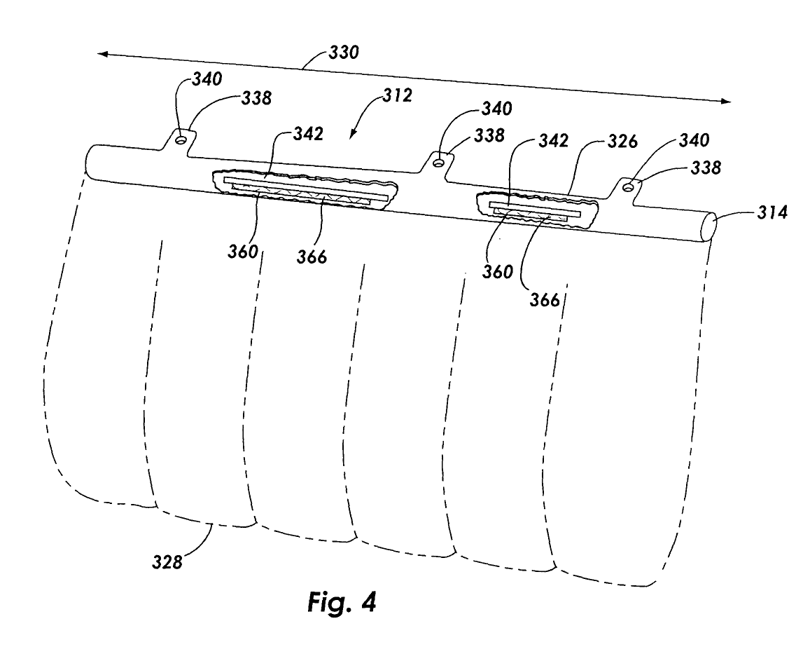

Referring now to FIG. 4, an additional embodiment of the present invention is depicted. FIG. 4 is a partially cutaway side plan view of an airbag assembly 312 that may be mounted onto a vehicle interior 10 (shown in FIG. 1). As can be seen in FIG. 4, most of the components and elements of the airbag assembly 312 are similar and/or equivalent to the components and elements that are found in the embodiments described above.

The airbag assembly 312 comprises an inflatable curtain 314. The inflatable curtain 314 has two configurations: a stowed configuration in which the inflatable curtain 314 has been rolled, folded, or otherwise gathered into a bundle, and an inflated configuration (shown in phantom lines) that is capable of protecting a vehicle occupant during a crash. The inflatable curtain 314 has a top end 326, a bottom 328, and a longitudinal length 330. One or more attachment tabs 338 having a hole 340 may also be added proximate to the top end 326.

The airbag assembly 312 further comprises a stiffening member 342 that is attachable to the vehicle interior 310 and/or the inflatable curtain 314. The stiffening member 342 is disposed at or proximate to the top end 328. More than one stiffening member 342 may also be used. In fact, as seen in FIG. 4, two stiffening members 342 have been added. The stiffening member 342 extends along at least a portion of the longitudinal length 330 and is constructed such that when it is attached to the inflatable curtain 314, the stiffening member 342 resists twisting of the curtain 314 along a portion of the longitudinal length 330.

As with the previous embodiment, the stiffening member 342 is attached to the inflatable curtain 314. However, unlike the previous embodiment, the stiffening member 342 is not attached to the attachment tabs 338. Rather, the stiffening member 342 is attached below the attachment tabs 338 such that the stiffening member 342 becomes positioned between two of the attachment tabs 338.

The stiffening member 342 is constructed such that at least a portion of the stiffening member 342 is inside the curtain 314. This may be accomplished by constructing the stiffening member 342 with one or more flaps 362. The flaps 362 are sections or portions of the stiffening member 342 that are made of material such as fabric and the like. Preferably, the flap 360 is constructed such that the stiffening member 342 may be attached to the curtain 314 by sewing or stitching along sew line 366.

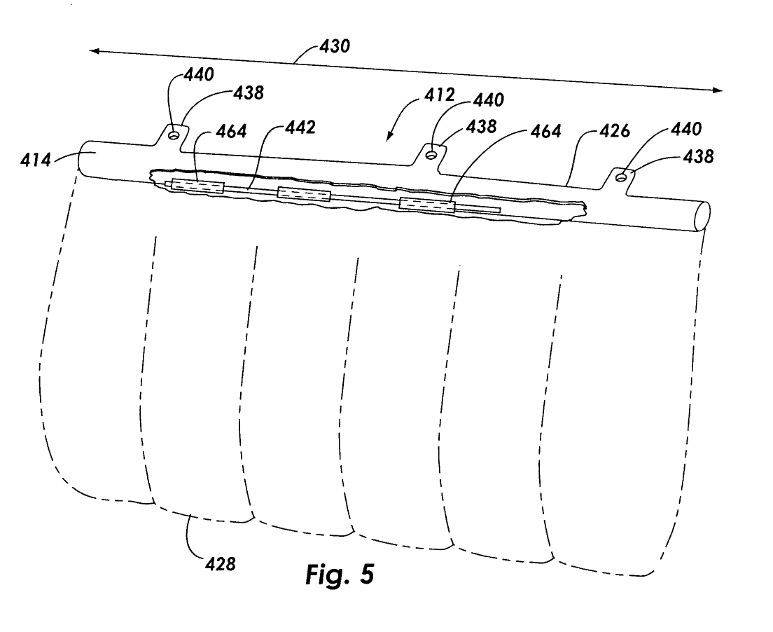

Referring now to FIG. 5, a further embodiment of the present invention is depicted. FIG. 5 is a partially cutaway side plan view of an airbag assembly 412 that may be mounted onto a vehicle interior 10 (shown in FIG. 1). As can be seen in FIG. 5, most of the components and elements of the airbag assembly 412 are similar and/or equivalent to the components and elements that are found in the embodiments described above.

The airbag assembly 412 comprises an inflatable curtain 414. The inflatable curtain 414 has two configurations: a stowed configuration in which the inflatable curtain 414 has been rolled, folded, or otherwise gathered into a bundle, and an inflated configuration (shown in phantom lines) that is capable of protecting a vehicle occupant during a crash. The inflatable curtain 414 has a top end 426, a bottom 428, and a longitudinal length 430. One or more attachment tabs 438 having a hole 440 may additionally be added proximate to the top end 426.

The airbag assembly 412 further comprises a stiffening member 442 that is attachable to the vehicle interior 410 and/or the inflatable curtain 414. The stiffening member 442 is disposed at or proximate to the top end 428. More than one stiffening member 442 may also be used. The stiffening member 442 extends along at least a portion of the longitudinal length 430 and is constructed such that when it is attached to the inflatable curtain 414, the stiffening member 442 resists twisting of the curtain 414 along a portion of the longitudinal length 430.

As with the previous embodiment, the stiffening member 442 is attached to the inflatable curtain 414 below the attachment tabs 438 and is constructed such that at least a portion of the stiffening member 442 may be positioned inside of the curtain 414. This may be accomplished by fitting the stiffening member 442 into one or more pockets 464 that have been sewn or otherwise added to the curtain 414. In the embodiment shown in FIG. 5, the stiffening member 442 has been threaded through three pockets 464 that have been positioned along the longitudinal length 430 of the curtain 414. Of course, other embodiments may be made in which the stiffening member 442 is fully enveloped or covered by only one pocket 464.

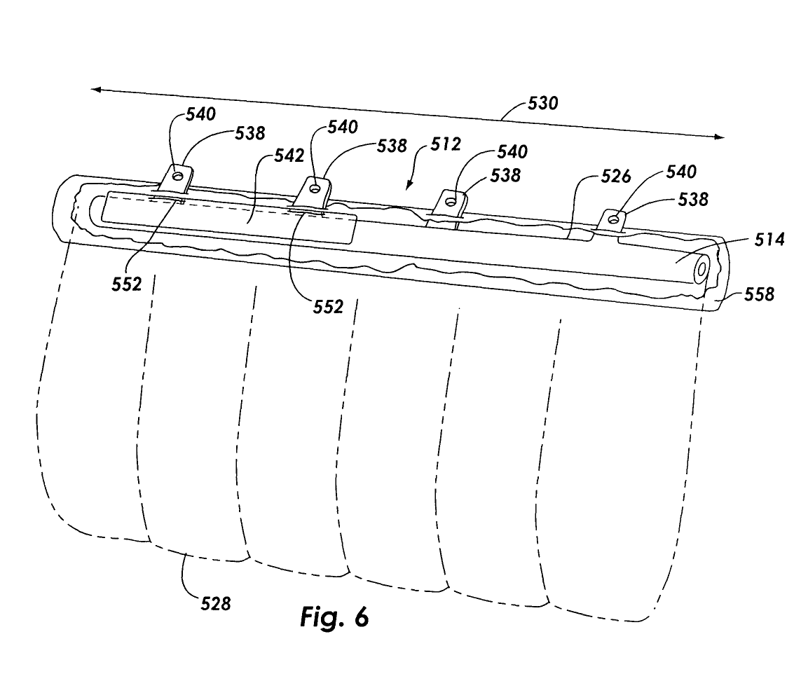

Referring now to FIG. 6, a further embodiment of the present invention is depicted. FIG. 6 is a partially cutaway side plan view of an airbag assembly 512 that may be mounted onto a vehicle interior 10 (shown in FIG. 1). As can be seen in FIG. 6, most of the components and elements of the airbag assembly 412 are similar and/or equivalent to the components and elements that are found in the embodiments described above.

The airbag assembly 512 comprises an inflatable curtain 514. The inflatable curtain 514 has two configurations: a stowed configuration and an inflated configuration (shown in phantom). The inflatable curtain 514 has a top end 526, a bottom 528, and a longitudinal length 530. One or more attachment tabs 538 having a hole 540 may also be included proximate to the top end 526.

The airbag assembly 512 further comprises a stiffening member 542 that is disposed at or proximate to the top end 528. More than one stiffening member 542 may also be used. The stiffening member 542 extends along at least a portion of the longitudinal length 530. Preferably, at least a portion of the stiffening member 542 is positioned inside of the inflatable curtain 514. As with the embodiment shown in FIG. 3, the stiffening member 542 includes one or more slits 552 such that the stiffening member 542 may be attached to the curtain 514 by passing one or more of the attachment tabs 538 through the slits 552. A wrapper 558 may also be added to enclose both the stiffening member 542 and the inflatable curtain 514.

Like the embodiments described above, the stiffening member 542 is a bar, plate, rod, or other similar feature. Preferably, the bar is made of a plastic material such as polypropylene and has a thickness that is between about 1 to about 3 millimeters. Of course, embodiments may also be made in which the stiffening member 542 is constructed of metal, composite materials, other plastics, and/or other similar materials. Additional embodiments may be made in which the thickness of the stiffening member 542 is greater than about 3 millimeters. Other embodiments may have the thickness of the stiffening member 542 be less than about 1 millimeter.

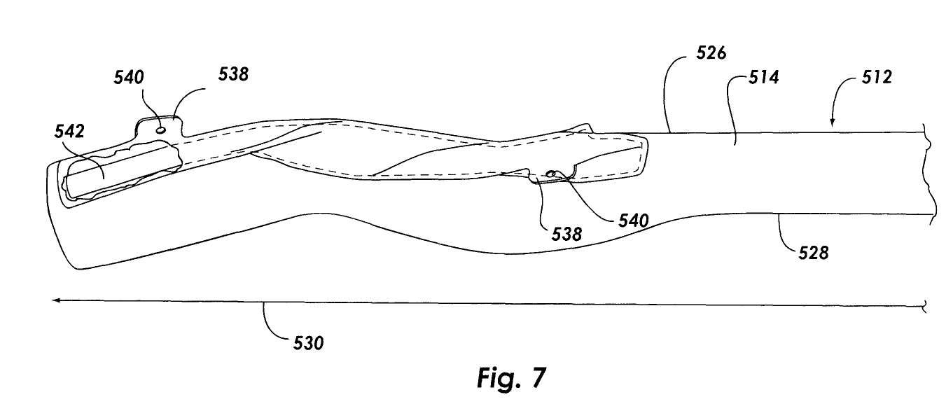

Referring now to FIG. 7, a partially cutaway perspective view of the airbag assembly 512 is illustrated. Unlike the embodiments described above in conjunction with FIGS. 1-5, the stiffening member 542 does not prevent the curtain 514 from twisting along a portion of the longitudinal length 530. Rather, as can be seen in FIG. 7, the stiffening member 542 is constructed such that when the curtain 514 is twisted, the stiffening member 542 will deform the curtain 514. More specifically, the stiffening member 542 is constructed such that when the curtain 514 is twisted, the stiffening member 542 will deform the curtain 514 such that the curtain 514 cannot be installed onto a vehicle interior 10 (shown in FIG. 1) without first correcting the deformation.

In the embodiment shown in FIG. 7, the airbag assembly 512 is configured such that when the curtain 514 is twisted, the stiffening member 542 deforms the curtain 514 by varying the position and/or orientation of the attachment tabs 538 along the longitudinal length 530 of the curtain 514. Of course, other embodiments may also be made in which the airbag assembly 512 is configured such that when the curtain 514 is twisted, the stiffening member 542 deforms the shape, configuration, orientation, and/or position of the curtain 514, the top end 526, the bottom end 528, and/or the longitudinal length 530.

Referring now to FIGS. 1-7 generally, the present invention also provides for an efficient method of resisting twisting of an inflatable curtain. First, an inflatable curtain and a stiffening member are obtained. Once these components have been obtained, the stiffening member is attached to the inflatable curtain. Preferably, the stiffening member is attached to or below one or more attachment tabs that have been positioned on the inflatable curtain.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag assembly comprising:
an inflatable curtain; and
a stiffening member that extends along at least a portion of the longitudinal length of the inflatable curtain, the stiffening member being disposed at or proximate to the top end of the inflatable curtain and constructed to resist twisting of the inflatable curtain along a portion of the longitudinal length.

2. An airbag assembly as in claim 1 wherein the stiffening member is made of a plastic material.

3. An airbag assembly as in claim 1 wherein the thickness of the stiffening member is between about 1 to about 3 millimeters.

4. An airbag assembly as in claim 1 wherein the stiffening member extends along the entirety of the longitudinal length of the inflatable curtain.

5. An airbag assembly as in claim 1 wherein the stiffening member comprises a bar.

6. An airbag assembly as in claim 1 wherein stiffening member includes a flap.

7. An airbag assembly as in claim 6 wherein the flap is attached to the inflatable curtain by sewing or stitching along a sew line.

8. An airbag assembly as in claim 1 wherein the stiffening member fits into one or more pockets that have been added to the inflatable curtain.

9. An airbag assembly as in claim 1 wherein the inflatable curtain and the stiffening member are held within a wrapper.

10. An airbag assembly as in claim 1 wherein the stiffening member is attached to the inflatable curtain via one or more mounting brackets.

11. An airbag assembly as in claim 1 wherein the inflatable curtain further comprises one or more attachment tabs.

12. An airbag assembly as in claim 11 wherein the attachment tabs are inserted through one or more apertures in the stiffening member.

13. An airbag assembly as in claim 11 wherein the stiffening member is attached to the attachment tabs.

14. An airbag assembly as in claim 11 wherein the stiffening member is attached below the attachment tabs.

15. An airbag assembly as in claim 11 wherein the stiffening member is positioned between two attachment tabs.

16. An airbag assembly as in claim 1 wherein the stiffening member serves as a shape-maintainer.

17. An airbag assembly that is attachable to a vehicle interior having a roof rail, the assembly comprising:
an inflatable curtain; and
a stiffening member that is attachable to the vehicle interior or the inflatable curtain, the stiffening member being positioned outside of the inflatable curtain and extending along at along at least a portion of the longitudinal length of the inflatable curtain, the stiffening member being disposed at or proximate to the top end of the inflatable curtain and constructed to resist twisting of the inflatable curtain along a portion of the longitudinal length.

18. An airbag assembly as in claim 17 wherein the stiffening member is made of a plastic material.

19. An airbag assembly as in claim 17 wherein the thickness of the stiffening member is between about 1 to about 3 millimeters.

20. An airbag assembly as in claim 17 wherein the stiffening member extends along the entirety of the longitudinal length of the inflatable curtain.

21. An airbag assembly as in claim 17 wherein the stiffening member comprises a bar.

22. An airbag assembly as in claim 17 wherein the inflatable curtain and the stiffening member are held within a wrapper.

23. An airbag assembly as in claim 17 wherein the stiffening member is attached to the inflatable curtain via one or more mounting brackets.

24. An airbag assembly as in claim 17 wherein the inflatable curtain further comprises one or more attachment tabs.

25. An airbag assembly as in claim 24 wherein the attachment tabs are inserted through one or more apertures in the stiffening member.

26. An airbag assembly as in claim 24 wherein the stiffening member is attached to the attachment tabs.

27. An airbag assembly as in claim 24 wherein the stiffening member is attached below the attachment tabs.

28. An airbag assembly as in claim 24 wherein the stiffening member is positioned between two attachment tabs.

29. An airbag assembly as in claim 17 wherein the stiffening member serves as a shape-maintainer.

30. An airbag assembly that is attachable to a vehicle interior having a roof rail, the assembly comprising:
an inflatable curtain; and
a stiffening member that is attachable to the vehicle interior or the inflatable curtain, the stiffening member extending along at along at least a portion of the longitudinal length of the inflatable curtain, the stiffening member being disposed at or proximate to the top end of the inflatable curtain and positioned such that at least a portion of the stiffening member is inside the inflatable curtain, wherein the stiffening member is constructed to resist twisting of the inflatable curtain along a portion of the longitudinal length.

31. An airbag assembly as in claim 30 wherein the stiffening member is made of a plastic material.

32. An airbag assembly as in claim 30 wherein the thickness of the stiffening member is between about 1 to about 3 millimeters.

33. An airbag assembly as in claim 30 wherein the stiffening member extends along the entirety of the longitudinal length of the inflatable curtain.

34. An airbag assembly as in claim 30 wherein the stiffening member comprises a bar.

35. An airbag assembly as in claim 30 wherein stiffening member includes a flap.

36. An airbag assembly as in claim 35 wherein the flap is attached to the inflatable curtain by sewing or stitching along a sew line.

37. An airbag assembly as in claim 30 wherein the stiffening member fits into one or more pockets that have been added to the inflatable curtain.

38. An airbag assembly as in claim 30 wherein the inflatable curtain and the stiffening member are held within a wrapper.

39. An airbag assembly comprising:
an inflatable curtain; and
a stiffening member that extends along at least a portion of the longitudinal length of the inflatable curtain, the stiffening member being disposed at or proximate to the top end and constructed to deform the inflatable curtain when the inflatable curtain is twisted such that the inflatable curtain cannot be installed onto a vehicle without correction of the deformation.

40. An airbag assembly as in claim 39 wherein the stiffening member is made of a plastic material.

41. An airbag assembly as in claim 39 wherein the stiffening member is positioned such that at least a portion of the stiffening member is inside the inflatable curtain.

42. An airbag assembly as in claim 39 wherein the thickness of the stiffening member is between about 1 to about 3 millimeters.

43. An airbag assembly as in claim 39 wherein the stiffening member is a bar.

44. An airbag assembly as in claim 39 wherein the inflatable curtain and the stiffening member are held within a wrapper.

45. An airbag assembly as in claim 39 wherein the inflatable curtain further comprises one or more attachment tabs.

46. An airbag assembly as in claim 45 wherein the attachment tabs are passed through one or more apertures in the stiffening member.

47. An airbag assembly as in claim 45 wherein the stiffening member deforms the inflatable curtain when the inflatable curtain is twisted such that the position of the attachment tabs varies along the longitudinal length of the inflatable curtain.

48. A method for method of resisting twisting of an inflatable curtain comprising:
obtaining an inflatable curtain;
obtaining a stiffening member that is constructed to extend along at least a portion of the longitudinal length of the inflatable curtain, and
attaching the stiffening member to the inflatable curtain.

49. A method as in claim 48 wherein the stiffening member is constructed to resist twisting of the inflatable curtain along a portion of the longitudinal length.

50. A method as in claim 48 wherein the stiffening member is constructed to deform the inflatable curtain when the inflatable curtain is twisted such that the inflatable curtain cannot be installed onto a vehicle without correction of the deformation.

51. A method as in claim 48 wherein the stiffening member is attached to one or more attachment tabs that are positioned on the inflatable curtain.

52. A method as in claim 48 wherein the stiffening member is attached below one or more attachment tabs that are positioned on the inflatable curtain.
